(19) United States
(12) Patent Application Publication
(10) Pub. No.: US 2004/0016702 A1
(43) Pub. Date: Jan. 29, 2004

(54) Device and method for purification of nucleic acids

(75) Inventors: Kevin M. Hennessy, San Mateo, CA (US); Aldrich N.K. Lau, Palo Alto, CA (US); Michael P. Harrold, Santa Mateo, CA (US)

Correspondence Address: MILA KASAN, PATENT DEPT., APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 10/413,797

(22) Filed: Aug. 11, 2003

Related U.S. Application Data
(60) Provisional application No. 60/398,852, filed on Jul. 26, 2002.

(51) Int. Cl. B01D 15/00

(52) U.S. Cl. 210/660

(57) ABSTRACT

A device for purifying a sample is provided, and includes ion-exchange particles in contact with a substrate. The device can include size-exclusion material and an ion-exchange material.

### CROSS-REFERENCE TO RELATED APPLICATION

Cross-reference is made to concurrently filed U.S. patent application Ser. No. ______, to Lau et al., entitled “Size-Exclusion Ion-Exchange Particles,” Attorney Docket No. 4885, which claims priority from U.S. Provisional Patent Application No. 60/398,852 filed Jul. 26, 2002. Cross-reference is also made to concurrently filed U.S. patent application Ser. No. ______ to Ramstad et al., entitled “Petal-Array Support for use with Microplates,” Attorney Docket No. 4329 I1 which is a continuation-in-part of U.S. patent application Ser. No. 10/038,974 to Ramstad, filed Jan. 4, 2002. Both of the above-identified concurrently filed and cross-referenced applications and all other patents and patent applications mentioned herein are incorporated herein in their entireties by reference.

### FIELD

The present teachings relate to apparatuses and methods for purifying a sample through ion-exchange.

### BACKGROUND

Purification of the reaction products of, for example, polymerase chain reaction (PCR) or a sequencing reaction, can present a number of challenges for subsequent, downstream processing. Impurities can cause artifacts in subsequent processing steps. Numerous purification steps to eliminate artifacts can be cumbersome and inefficient. Further, purification, such as by size-exclusion chromatography or ion-exchange chromatography, requires a well-formed resin bed, without cracks, bubbles, or channels, as well as correct sample-loading techniques. The resin beds can be up to ten times the volume of the sample in size, requiring much space and increasing the cost of purification. A need exists for a purification method that addresses these and other problems associated with conventional techniques of purification.

### SUMMARY

According to various embodiments, an apparatus for filtration and/or purification of a sample is provided, wherein the apparatus includes ion-exchange particles in contact with a substrate.

According to various embodiments, an apparatus for filtration and/or purification of a sample is provided, wherein the apparatus includes size-exclusion ion-exchange particles in contact with a substrate. The size-exclusion ion-exchange (SEIE) particles can include an ion-exchange core micro-encapsulated by a shell. The ion-exchange core can include a solid core material capable of ion-exchange. According to various embodiments, the ion-exchange core can include a solid core material coated with an ion-exchange resin. The ion-exchange resin can be formed in situ on the core material. The shell can be capable of size-exclusion. The shell can include a size-exclusion hydrogel, for example, the polymerization product of a water-soluble reactive monomer.

According to various embodiments, an apparatus for filtration and/or purification of a sample is provided, wherein the apparatus includes anionic ion-exchange particles embedded in a substrate, wherein the substrate is capable of cation exchange. The anionic ion-exchange particles can be capable of size-exclusion.

According to various embodiments, an apparatus for filtration and/or purification of a sample is provided, wherein the apparatus includes ion-exchange particles in a substrate that includes a size-exclusion resin. The apparatus can be attached or otherwise connected to a support, or placed in a sample well.

According to various embodiments, a method is provided to filter a sample solution. The sample can contain, for example, primers, dye-labeled nucleotides, salts, oligonucleotides, and/or a mixture thereof. The method can include placing an apparatus capable of ion-exchange and/or size-exclusion in contact with the sample for a period of time sufficient for the apparatus to adsorb unwanted materials from the sample, resulting in a purified sample solution. The purification can occur in ten minutes or less, five minutes or less, or two minutes or less.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

FIG. 1a is a schematic diagram of an interaction of an anion with a size-exclusion ion-exchange particle, according to various embodiments;

FIG. 1b is a cross-sectional view through different lines, of an SEIE particle used according to various embodiments.

FIGS. 2a-d are schematic diagrams illustrating the making of a coated stick from a substrate and size-exclusion ion-exchange particles;

FIGS. 3a-d are schematic diagrams of a purification reaction using the coated stick of FIG. 2c;

FIGS. 4a-f are schematic diagrams illustrating the making of a purification dipstick from a substrate, ion-exchange particles, and a support;

FIGS. 5a-c are schematic diagrams of a purification reaction using the purification dipstick of FIG. 4f;

FIGS. 6a-e are schematic diagrams illustrating the making of a purification device from a substrate, ion-exchange particles, and a support;

FIGS. 7a-c are schematic diagrams of a purification reaction using the purification device of FIG. 6e;

FIGS. 8a-d are schematic diagrams illustrating the making of a gel plug from a substrate and ion-exchange particles;

FIGS. 9a-c are schematic diagrams of a purification reaction using the gel plug of FIG. 8d.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

It is to be understood that both the foregoing general description and the following detailed description are exemplary and explanatory only, and are intended to provide an explanation of various embodiments of the present teachings.

### DESCRIPTION OF VARIOUS EMBODIMENTS

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

It is noted that, as used in this specification and the appended claims, the singular forms “a,” “an,” and “the,” include plural referents unless expressly and unequivocally limited to one referent. Thus, for example, reference to “a monomer” includes two or more monomers.

According to various embodiments, size-exclusion ion-exchange (SEIE) particles having an ion-exchange core micro-encapsulated by a shell capable of size-exclusion are provided. The terms “micro-encapsulation,” “micro-encapsulated,” or the like, refer to a process of encapsulation on the individual particle level. In one embodiment, a core of liquid, solid, and/or gas is micro-encapsulated with a shell to control access to the core. In various other embodiments, micro-encapsulation can coat the entire exterior surface of the core (and optionally interior surfaces), or it can coat only a portion of the exterior surface of the core (and optionally interior surfaces). In various other embodiments, micro-encapsulation of the core can be irreversible to permanently coat the core, or reversible to release the core upon dissolution of the coating. According to various embodiments, micro-encapsulation can include encapsulation of an agglomerate of core material in a shell. The agglomerate can be fused, sintered, pressed, compressed, or otherwise formed together core materials. According to various embodiments, the core material can be a single particle and not an aggregate. As used herein, the term “core” or “core material” can refer to a single particle or an aggregate of particles. The term “shell” refers to coating any portion of the core exterior surface and/or interior surface. The dimensions and formation of the shell are described below. The term “material” refers to any substance on a molecular level or in bulk. As used below, a material can be a liquid and/or solid, e.g. an emulsion or a resin.

As used herein, a “mixture” can refer to more than one SEIE particle used together in a packed column, a mixed-bed, a homogenous bed, a fluidized bed, a static column with continuous flow, or a batch mixture, for example. The mixture can include size-exclusion cation-exchange particles and size-exclusion anion-exchange particles, size-exclusion cation-exchange particles and anion-exchange particles, size-exclusion anion-exchange particles and cation-exchange particles, SEIE particles and inerts, and other materials that have affinity adsorption/absorption characteristic capable of removing organo- and bio-molecules from the analyte or a combination thereof. The mixture can include any physical configuration known in the art of separations, and any chemical mixture known in the art of ion exchange.

Small molecules, such as, for example, inorganic ions and nucleotides, can penetrate or permeate through the size-exclusion shell and can be retained by or ion-exchanged with the ion-exchange core. The shell can prevent larger ions, such as, for example, DNA fragments, from penetrating or permeating through the shell and reacting with the ion-exchange core.

According to various embodiments, SEIE particles can have many uses such as, for example, in the purification of biomolecules. Applications can include, for example, purification of polymerase chain reaction (PCR) products, purification of DNA sequencing reaction mixtures, and purification of RNA. SEIE particles can also be used for purification and/or separation of, for example, oligonucleotides, ligase chain reaction products, proteins, antibody binding reaction products, oligonucleotide ligation assay products, hybridization products, and antibodies. SEIE particles can also be used for desalting of biological products or reaction mixtures.

SEIE particle, according to various embodiments, combine the benefits of size-exclusion chromatography (SEC) with the benefits of ion-exchange chromatography (IEC). Both SEC and IEC can be used for purification of biomolecules. According to various embodiments, SEC can separate molecules on the basis of their hydrodynamic volume, with larger molecules requiring less eluent, for example, a lesser elution volume, than smaller molecules. In SEC, the larger molecules can elute first. SEC can be used in a “spin column” format for biomolecule purification, wherein the column is not required to continually elute but can, for example, elute with a fixed volume, such as the volume in the sample. In a spin column format SEC, larger molecules can be eluted from the column while smaller molecules remain in the column and can later be discarded. SEC can be used for group separation, for example, for the purification of DNA sequencing reactions or the purification of PCR products, wherein the desired product, for example, a sequencing ladder or a PCR product, can flow through the column while undesirable products, for example, primers and ions that are not of interest, remain trapped in the column. SEC can also be used for desalting applications where salts are retained in the column.

IEC can differ from SEC, for example, in the order of elution of species from a column. According to various embodiments, IEC selectivity can be based on, for example, the charge of the analyte. Larger molecules can have a higher charge, and thus a higher affinity for the IEC resin than smaller molecules. Biopolymers, for example, DNA, have a high affinity for IEC resin because the charge of the species increases linearly with the size of the molecule, such that larger molecules can have a higher charge than smaller molecules. Smaller, lesser-charged species, for example, salts and nucleotides, can rapidly elute from an IEC column while a larger species such as, for example, PCR products or DNA sequencing ladders, can be strongly bound to the IEC column and can elute later, or not elute at all. Thus, IEC and SEC can result in different elution orders, with SEC first eluting larger molecules, and IEC first eluting smaller molecules.

According to various embodiments, SEIE particles can enable high quality separation of biomolecules by combining the effects of SEC and IEC. SEIE particles can use a size-exclusion shell to restrict the ability of large molecules to interact with an ion-exchange core. SEIE particles can combine the high selectivity and binding ability of IEC resins with the size-exclusion benefits of SEC. Small molecules that can penetrate the size-exclusion shell of the SEIE particle can interact with the ion-exchange core and can be retained on the core. Larger, highly charged species can be restricted from interacting with the ion-exchange core by the size-exclusion shell of the SEIE particle. Such larger, highly charged species can remain in solution rather than bind to the ion-exchange core. Larger species that remain in solution can be eluted. Eluting SEIE particles can differ from elution of an SEC column in that additional volume in an SEIE column or bed optionally does not elute the bound material because the bound material is held on the ion-exchange core of the SEIE particles, and can be kept from reacting with an eluent to be removed from the column or bed. Further details about size-exclusion ion-exchange particles that can be used according to various embodiments, are described in concurrently filed U.S. patent application Ser. No. ______ to Lau et al., entitled “Size-Exclusion Ion-Exchange Particles,” Attorney Docket No. 4885, which is incorporated herein in its entirety by reference.

According to various embodiments, a device for purification of a sample, for example, a sample having nucleic acids, is provided. The device can be capable of size-exclusion, ion-exchange, or both. The device can retain small molecules, such as, for example, inorganic ions and nucleotides, from a sample solution. According to various embodiments, the device can selectively prevent adsorption of larger ions, such as, for example, DNA fragments, onto the device, leaving such larger ions in the sample solution. The device can be used for purification of a sample of biological material at one or more of various steps in a processing sequence, for example, PCR, DNA sequencing reaction, and other processes described elsewhere herein.

According to various embodiments, the purification device can include a substrate capable of retaining particles, wherein the particles are capable of ion-exchange. The particles can be embedded in the substrate in whole or in part. The particles can be capable of size-exclusion. According to various embodiments, the substrate can be capable of size-exclusion. The device can be used to purify a sample solution by a combination of size-exclusion and ion-exchange, or SEIE.

SEIE can be accomplished using a particle capable of ion-exchange, and a resin capable of size-exclusion. The resin can form a coating, for example, a shell, on the particle, or the resin can be a substrate within which the ion-exchange particles are dispersed. The size-exclusion resin can restrict the ability of molecules to interact with the ion-exchange particles, combining the high selectivity and binding ability of IEC with the size-exclusion of SEC. As used herein, “resin” includes compositions with the characteristics of a resin or a gel.

According to various embodiments, small molecules present in a sample solution can penetrate a size-exclusion resin to interact with an ion-exchange particle and be retained on the ion-exchange particle. Larger, highly charged species in the sample solution can be restricted from reacting with the ion-exchange particle by the size-exclusion resin. Such larger, highly charged species can remain in the sample solution rather than binding to the ion-exchange particle.

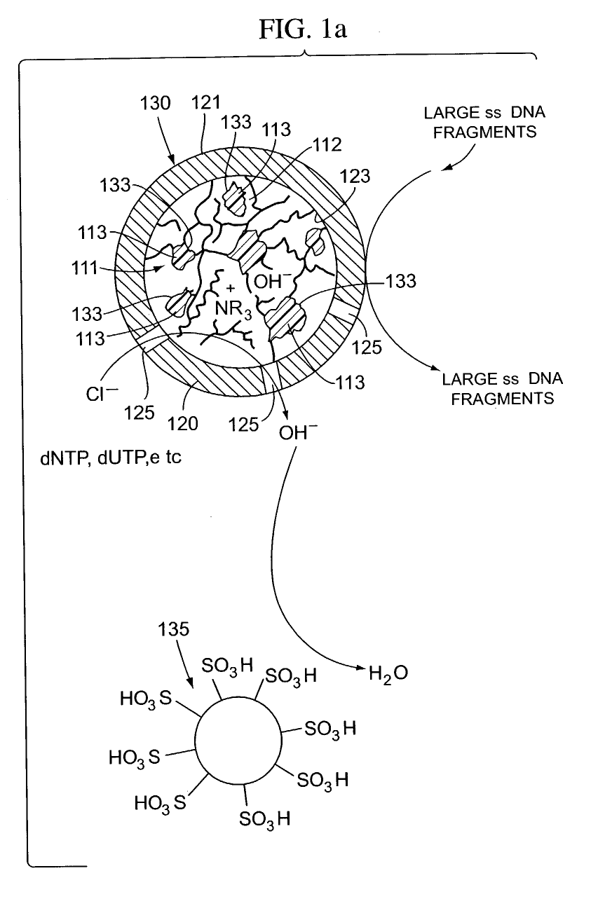

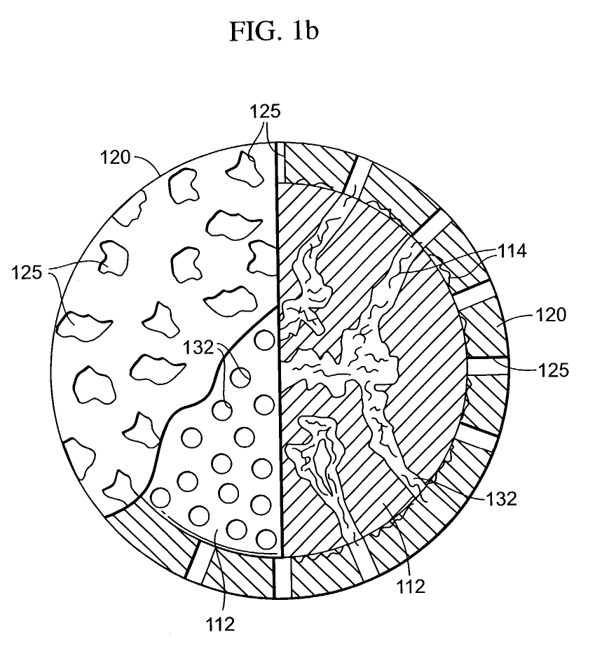

An example of an SEIE particle that can be used as part of a device according to various embodiments, is shown in FIGS. 1a and 1b. An interaction involving the SEIE particle, is shown in FIG. 1a. FIGS. 1a and 1b are not drawn to scale, and the relation between objects in the figures, such as the relation between core pore sizes and shell pore sizes, is not to scale, and can in fact be inverse, such that the core pore size is larger than the shell pore size. As seen in FIGS. 1a and 1b, large molecules, such as long single stranded DNA (ssDNA) fragments, and double stranded DNA (dsDNA), are too large to pass through a pore 125 of a size-exclusion shell 120 of a size-exclusion anion-exchange particle 130. Instead, large molecules can slide past or bounce off an exterior surface 121 of the shell 120, and remain in solution rather than ion-exchanging with the anion-exchange particle 130. Small molecules, such as deoxynucleotide triphosphates (dNTPs), dye-labeled deoxynucleotide triphosphates, dideoxynucelotide triphosphates (ddNTPs), dye-labeled dideoxynucelotide triphosphates, and small ions, such as chloride, can pass through the pores 125 of the size-exclusion shell 120 and can undergo ion-exchange with anion-exchange resin 113 at or near the interface 123 of the shell and ion-exchange core 111, or within the pores of ion-exchange core 111. FIG. 1a shows a partial cut-away 133 showing a surface of the ion-exchange core 111 coated with anion-exchange resin 113. The anion-exchange resin 113, for example, a cross-linked, macroporous copolymer of methyl methacrylate and 2-hydroxy-3-methacryloyloxypropyltrimethylammonium chloride, can be present on all internal and external surfaces of the solid core material 112. Together, the anion-exchange resin and solid core material or support 112 form the anion-exchange core 111. Counter-anions released from the anion-exchange core 111, such as hydroxide, can react with a counter-cation, for example, hydronium, of a cation-exchanger 135 that can be provided in a mixture with the SEIE particle 130, to produce a neutral molecule such as water. A more-detailed cut-away view of the shell and core structure is provided in FIG. 1b.

SEIE particles can be used in a mixture, a mixed bed, or a homogeneous bed of particles. Wherein a homogeneous bed of anionic- or cationic-SEIE particles is used, the counter-ion can be released directly into a sample solution upon ion-exchange. In certain cases, the presence of the counter-ion in the sample solution does not affect further processing or reaction of the sample.

According to various embodiments, the selectivity of an SEIE particle can be determined by the nature of the size-exclusion shell, the charge of the ion-exchange core, and the nature of the counter-ion. The properties of the size-exclusion shell can be varied by, for example, choosing appropriate synthesis conditions that can affect the pore size of the resulting shell. Controlling an effective pore size of the size-exclusion shell can allow the SEIE particle to be optimized for different size-exclusion applications.

According to various embodiments, a purification device can include SEIE particles embedded in a substrate. The SEIE particles can be ion-exchange particles, as described elsewhere herein, micro-encapsulated by a size-exclusion resin, as described elsewhere herein. An ion-exchange particle can be micro-encapsulated by a size-exclusion resin, for example, by inverse emulsification and polymerization, to form an SEIE particle. For example, an anionic ion-exchange particle can be formed by impregnating polyethyleneimine onto the surface of a solid core material, including all surfaces of the pores of the solid core material, subsequently cross-linked by an alkyl dihalide, for example, 1,3-dibromopropane, and quarternized with an alkyl halide, for example, methyl bromide. The resultant ion-exchange particle can be encapsulated by a shell of size-exclusion resin, for example, polyacrylamide, to form a anionic SEIE particle. By methods known to one of ordinary skill in the art, other anion-exchange resins or cation-exchange resins can be impregnated or retained on at least a portion of the internal surfaces, on at least a portion of the external surface, or on at least a portion of all surfaces of the solid core material of the ion-exchange particle. According to various embodiments, a solid core material capable of ion-exchange can be micro-encapsulated by a size-exclusion resin to form an SEIE particle.

According to various embodiments, the ion-exchange particle can be surface-activated to enhance or aid in formation of the shell around the ion-exchange particle. Surface activation of the ion-exchange particle can include, for example, derivatization of functional groups on the ion-exchange particle by monomers; absorption of polyanions onto the ion-exchange particle by ionic interaction with an ion-exchange resin of the ion-exchange particle; passive adsorption onto the ion-exchange particle of a neutral, water-soluble, or at least partially water-soluble polymer; or adsorption of a charged initiator on the ion-exchange particle through ionic interaction.

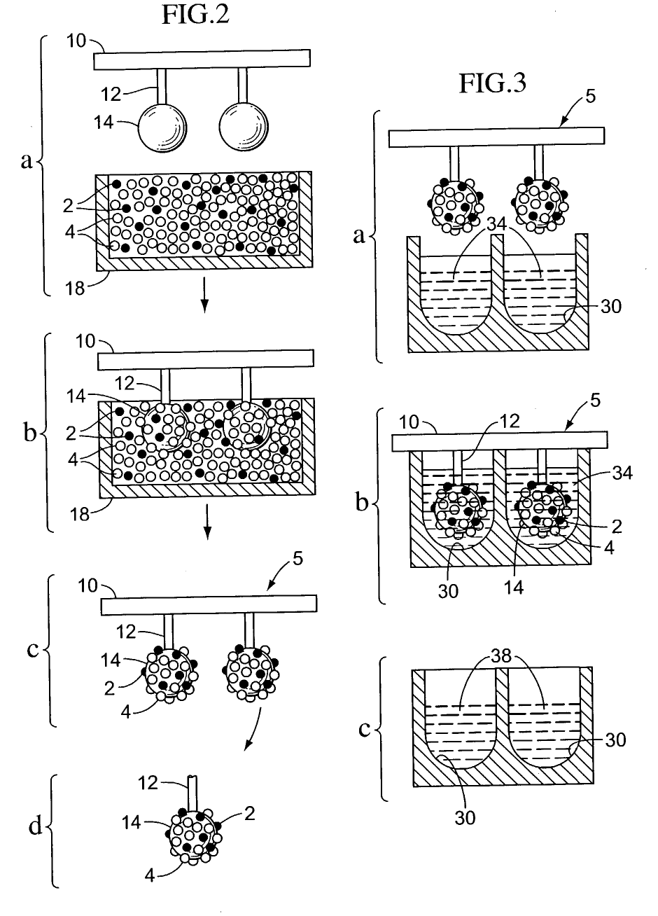

According to various embodiments, a purification device in the form of a coated stick can be made, wherein the coated stick has SEIE particles embedded in a substrate. The SEIE particles can be embedded in a substrate, for example, a polymeric substrate, by heat application, by heated extrusion of the substrate in the presence of the particles, by pressure, by physical force, by chemical treatment, by electrical current, by ultrasonication, by molding with the substrate, or by other methods of attachment known to those of ordinary skill in the art, or combinations thereof. For example, as shown in FIGS. 2a-c, SEIE particles can be embedded in a substrate by a combination of heating and physical pressure. Anionic SEIE particles 2 and cationic SEIE particles 4 are placed in a receptacle 18, for example, a dish, sample well, plate, container, or other device capable of holding the particles. A substrate having a support 10 with one or more protrusion 12 terminating in a ball-shaped distal end or portion 14 can be heated and/or chemically treated and pushed into the receptacle 18 containing the SEIE particles 2, 4. The SEIE particles 2, 4 can be heated and/or chemically treated in addition to, or instead of, heating or chemically treating the substrate. The substrate and/or SEIE particles can be heated to a temperature of from the glass transition temperature Tg to the melting temperature Tₘ of the substrate. For example, a polystyrene-containing substrate can be heated to a temperature of from 90° C. to 240° C. The physical force of pushing the substrate into the SEIE particles 2, 4 in receptacle 18 forces SEIE particles 2, 4 to embed in and/or adhere to the surface of the ball-shaped portion 14 of the substrate, as shown in FIGS. 2c and 2d, forming a purification device 5.

According to various embodiments, SEIE particles can be adhered to a polymeric substrate of a coated stick by chemically treating the polymeric substrate and/or the SEIE particles such that the particles adhere to the polymeric substrate physically and/or covalently. SEIE particles can be adhered to the polymeric substrate of a coated stick by forming a slurry of SEIE particles in a polymeric binder, and dipping the terminal portion of the polymeric substrate in the slurry. The slurry can include a monomer and one or more of a cross-linker, an initiator, and a catalyst. The slurry can be capable of forming a polymer at or below room temperature. The monomer can be a nitrogen-containing monomer, an acrylamide-containing monomer, an acrylate, or another monomer capable of cross-linking and known to those of ordinary skill in the art. The slurry can contain a polymer, for example, poly(meth)acrylamide, poly(N,N-dimethyl(meth)acrylamide), poly(hydroxyethyl(meth)acrylate), poly(vinylpyrrolidone), poly(vinylalcohol), poly(N-vinylamides), or a combination thereof. According to various embodiments, the slurry can contain an affinity adsorbent, for example, silica, alumina, diatomous earth, particles of polystyrene, PTFE, PVDF, a polyolefin, or a combination thereof. The cross-linker can be any suitable cross-linker, for example, bisacrylamide.

According to various embodiments, the substrate of the coated stick can be a polymeric material. For example, the substrate can be polystyrene or a copolymer of polystyrene. The substrate can be a petroleum based polymer, co-polymer or homopolymer. The polymeric substrate can be in the form of a support having one or more protrusion, wherein each protrusion has a terminal portion such as a distal end or distal tip. The terminal portion can be any suitable shape to provide a large surface area within a sample container for interaction with a sample solution. For example, the terminal portion can be ball-shaped, bell-shaped, flared, tubular, column-shaped, disc-shaped, ovoid, pin-shaped, baffled, or have any other suitable shape. The terminal portion of the polymeric substrate can be of a sufficient size to fit snuggly within a sample well while allowing a sample solution to flow between the interior walls of the sample container and the terminal portion of the polymeric substrate. For example, the terminal portion of the polymeric substrate can be ball-shaped and have a diameter of from 1 mm to 3 mm. Other suitable diameters complementary to a sample container size are also suitable. Cationic SEIE particles, anionic SEIE particles, or a combination thereof can be adhered to, contacted with, attached to, encapsulated by, and/or embedded in the polymeric substrate. When a mixture of cationic and anionic SEIE particles is included, the particles can be present in a stoichiometrically equivalent amount or in a non-stoichiometrically equivalent amount.

According to various embodiments, the polymeric substrate of a coated stick can be treated to function as a cation exchanger. For example, a polystyrene-containing substrate can be treated with sulfonic acid to provide cation exchange groups on the substrate, for example, on the protrusion and/or terminal portion. Anionic SEIE particles can be attached to and/or embedded in the terminal portion of the polymeric substrate. Such a purification device can provide both cation- and anion-exchange functions for purification of a sample solution.

According to various embodiments, the polymeric substrate can be capable of cation-exchange and/or anion-exchange. Exemplary suitable polymeric materials are set forth, for example, in U.S. Pat. Nos. 3,965,039 and 5,936,004, which are incorporated herein in their entireties by reference. According to various embodiments, the support and/or protrusions therefrom can be constructed of ion-exchange material and then at least partially coated with size-exclusion resin. In these embodiments the support and protrusions is active, as opposed to being inert. The term “inert” as used herein refers to a material that provides neither size-exclusion nor ion-exchange.

According to various embodiments, the coated stick can be treated with heparin or other suitable chemicals for adsorption of or interaction with impurities in a sample solution.

As illustrated in FIG. 3, purification of a sample can be achieved by inserting the purification device 5 into a sample receptacle, for example a sample container, a sample well array, receiving well array, or other device capable of containing a fluid sample. According to various embodiments, the number of sample wells 30 in a sample well array can be equivalent to, greater than, or less than the number of protrusions 12 on the purification device. As shown in FIG. 3a, one or more sample well 30 is filled with a sample 34. As shown in FIG. 3b, the purification device 5 can be inserted into the sample wells 30 such that support 10 contacts a top portion of sample wells 30, sealing the sample wells 30, preventing fluid loss from the sample wells 30, and/or preventing entrance of contaminants into the sample wells 30. When purification device 5 is placed in sample wells 30, protrusions 12 extend from support 10 such that terminal ball-shaped portions 14 embedded with or otherwise in contact with SEIE particles are fitted snuggly into respective sample wells 30. The terminal ball-shaped portion 14 having SEIE particles 2, 4 embedded thereon can be completely covered by sample 34 in each sample well 30. The purification device 5 remains in sample wells 30 for a period of time sufficient for the purification device to remove substantially all impurities from sample 34. Purification device 5 can be separated from the sample 34 after a sufficient time to remove substantially all impurities, for example, at least 70%, at least 80%, at least 90%, or at least 95% of impurities from sample 34, leaving purified sample 38 in sample wells 30, as shown in FIG. 3c. According to various embodiments, the purified sample can be separated from the purification device, for example, by movement of the sample well array, or by opening a closable valve in the sample well to allow the purified sample to flow from the sample well. The used purification device can be discarded, washed for re-use, or used to provide materials for a subsequent reaction.

According to various embodiments, a purification device can include a substrate capable of retaining ion-exchange particles, wherein the substrate is capable of size-exclusion. The substrate can be on or in a support structure. The substrate can be a size-exclusion resin as defined elsewhere herein. The ion-exchange particles can be as defined elsewhere herein.

According to various embodiments, the support structure can include a polymeric material. For example, the support structure can include polystyrene or a copolymer of polystyrene. The support structure can include a petroleum-based polymer, co-polymer or homopolymer. The support structure can be glass or ceramic. The support structure can be a planar structure capable of receiving, holding, or retaining the substrate. The planar structure can be a cover having a recess for receiving the substrate. The support structure can have one or more protrusion, wherein each protrusion has a terminal portion. The terminal portion can be any suitable shape to provide a surface area for interaction with a sample solution. For example, the terminal portion can be ball-shaped, bell-shaped, flared, tubular, column-shaped, disc-shaped, ovoid, pin-shaped, or any other suitable shape. The terminal portion of the support structure can be of a sufficient size to fit snuggly within a sample container while allowing a sample solution to flow between the interior walls of the sample container and the terminal portion of the support structure.

According to various embodiments, the support structure can be in the form of a sample container, for example, a sample well, a reaction region, a depression, or other receptacle capable of retaining or containing the purification device and a sample. The receptacle can be one of a number of connected receptacles, for example, a receptacle in a sample well tray, a reaction region array, or any other multiple sample device as known to those of ordinary skill in the art. The support can have an internal diameter of, for example, about 3 mm. Other suitable diameters can be used.

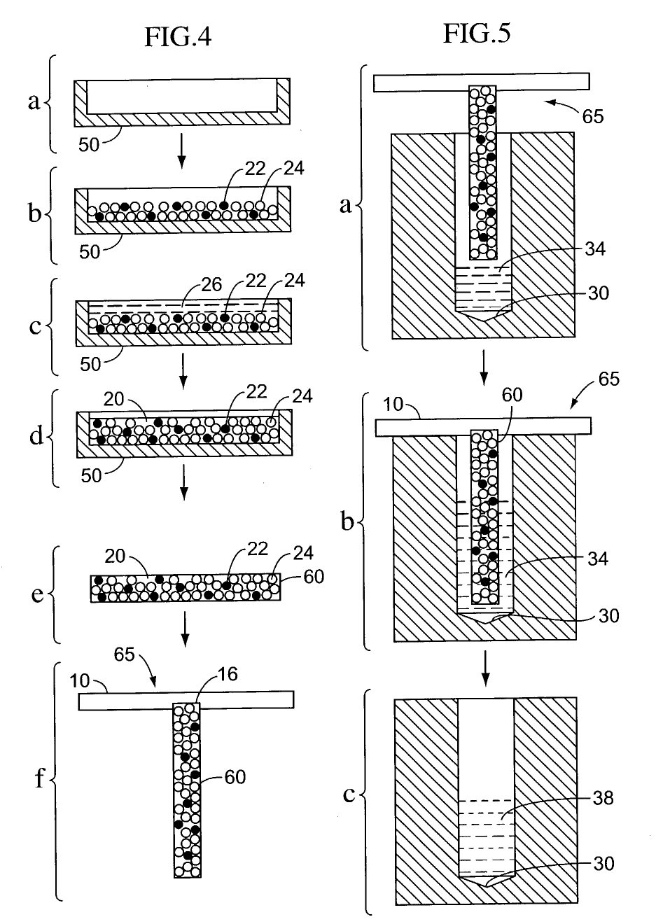

According to various embodiments, and as shown in FIGS. 4 and 5, a purification device 65 can include a dipstick 60 having a substrate containing ion-exchange particles. The dipstick 60 can be fitted into a support 10. As shown in FIGS. 4a-f, the dipstick 60 can be formed by inserting ion-exchange particles 22, 24 into a form 50, such as a mold, sample well, or other receptacle capable of retaining the ion-exchange particles 22, 24 and substrate in a desired shape or form. As shown in FIG. 4c, a monomer solution including one or more monomers and/or polymers 26 capable of cross-linking to form a substrate 20 of size-exclusion resin can be added to the form 50. The monomer solution 26 can include one or more initiator, cross-linker, chain transferring agent, surfactant, catalyst, terminator, promoter, buffer, accelerator, or a combination thereof. The monomer solution can be capable of polymerizing and/or cross-linking at about room temperature. The monomer solution can be capable of polymerizing upon application of heat, application of radiation, addition of a catalyst, addition of an initiator, or a combination thereof. The monomer solution can substantially cover the ion-exchange particles in the mold such that a portion or none of the ion-exchange particles protrudes above the monomer solution. The monomer solution can be polymerized and/or cross-linked to form a substrate of size-exclusion resin 20 encapsulating ion-exchange particles 22, 24, as shown in FIG. 4d. Once the substrate is polymerized and/or cross-linked, the dipstick 60 can be removed from mold 50, as shown in FIG. 4e. The dipstick can be used for purification of a sample solution in its de-molded state, or can be attached to a support 10, as shown in FIG. 4f. The monomer solution can contain a polymer, for example, poly(meth)acrylamide, poly(N,N-dimethyl(meth)acrylamide), poly(hydroxyethyl(meth)acrylate), poly(vinylpyrrolidone), poly(vinylalcohol), poly(N-vinylamides), or a combination thereof. According to various embodiments, the polymer solution can contain an affinity adsorbent, for example, silica, alumina, diatomous earth, particles of polystyrene, PTFE, PVDF, a polyolefin, or a combination thereof. According to various embodiments, a dipstick can be formed from SEIE particles encapsulated by an inert porous resin that provides support for particles and access to the sample.

According to various embodiments, the dipstick is formed with a length and diameter complementary to, and slightly smaller than, a sample well with which the purification device is intended to be used. The dipstick can be of a size and shape to fit snugly within the sample container. For example, when the sample container is a sample well of a sample well array, the dipstick can be column-like in shape, having a blunt or rounded terminal end, and having a diameter less than that of the sample well, or less than about three millimeters, and a length sufficient to span the distance from just above the bottom of the sample well to the support when the support is fitted onto a surface of the sample well array. The shape of the dipstick and sample container can be complimentary, and the dipstick can have a length exceeding its diameter, for example for use with a sample well array, or a diameter exceeding its length, for example, for use with a Petri dish.

The support 10 can be of any shape suitable to retain one or more sides of the dipstick 60 in an orientation suitable for interaction with a sample solution in a sample container. The support 10 can function as a cover on the sample container during reaction of the dipstick 60 and the sample solution. For example, and as shown in FIG. 4f, the support 10 can be planar. The support 10 can include a recess 16 capable of retaining the dipstick 60 in a desired orientation, forming purification device 65. The purification device can include one dipstick 60 or multiple dipsticks 60 attached to the support 10. The number of dipsticks 60 can be equal to, less than, or greater than the number of sample containers in, for example, a sample well array, allowing purification of multiple sample containers simultaneously. One or more dipstick 60 can be attached to the support 10 permanently or removably by an adhesive, screw-fit, friction-fit, or any other retaining method known to one of ordinary skill in the art.

In use, as shown in FIGS. 5a-c, the purification device 65 can be inserted into a sample container, for example a sample well 30 having a sample solution 34 therein. The purification device 65 can be inserted so that the support 10 contacts the sample well 30, sealing the sample well during reaction of the sample solution 34 and dipstick 60. The purification device 65 is kept in contact with the sample solution 34 for a period of time sufficient to remove substantially all impurities, for example, at least 70%, at least 80%, at least 90%, or at least 95% of impurities from the sample solution 34. After a sufficient time, the purification device 65 can be separated from the purified solution 38 in sample well 30. According to various embodiments, the purified sample can be separated from the purification device, for example, by movement of the sample well, or by opening a closable valve in the sample well to allow the purified sample to flow from the sample well. The used purification device can be discarded, washed and reused, or can be used to transfer the adsorbed material to another reaction chamber.

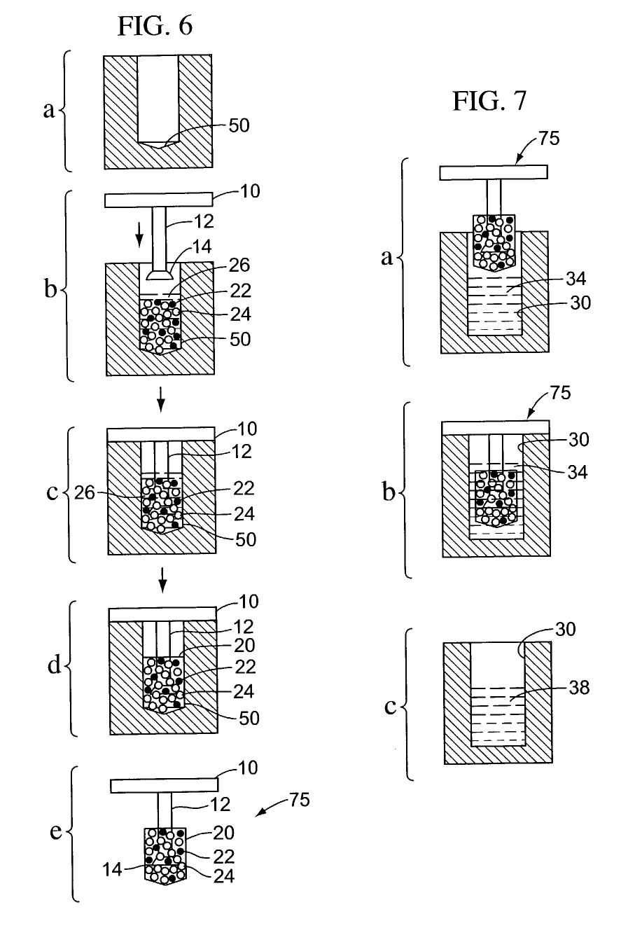

According to various embodiments, a purification device 75 in the form of a coated stick or popsicle stick can be formed, as shown, for example, in FIGS. 6 and 7. One method of forming the popsicle stick is shown in FIGS. 6a-e. A mold 50 or other suitable receptacle can be obtained, wherein the mold 50 has a shape approximating the shape of a sample container with which the purification device 75 can be used. The inside of the mold 50 can be slightly smaller in diameter and height than the sample container. Ion-exchange particles 22, 24 and monomer solution 26 as described previously herein can be added to mold 50. According to various embodiments, the polymer solution can contain an affinity adsorbent, for example, silica, alumina, diatomous earth, particles of polystyrene, PTFE, PVDF, a polyolefin, or a combination thereof. Support 10 having a protrusion 12 and a terminal end 14 can be inserted into the mixture of ion-exchange particles 22, 24 and monomer solution 26. The monomer solution 26 is polymerized and/or cross-linked to form a substrate of size-exclusion resin 20 encapsulating the ion-exchange particles 22, 24, wherein the size-exclusion resin 20 is in the form of a gel plug surrounding and attached to the terminal end 14. Optionally, the gel plug can be attached to at least a portion of protrusion 12 of support 10. The popsicle stick can be formed such that the gel plug is slightly smaller in diameter and height than the corresponding sample container. The ion-exchange particles 22, 24 can protrude partially beyond the size-exclusion resin 20. The support 10 having a gel plug affixed thereto, wherein the gel plug includes a substrate of size exclusion resin 20 encapsulating ion-exchange particles 22, 24, can be removed from mold 50 and used as a purification device 75. The purification device can include one popsicle stick or multiple popsicle sticks attached to the support 10. The number of popsicle sticks can be equal to, less than, or greater than the number of sample wells in, for example, a sample well array, allowing purification of multiple wells simultaneously. The protrusion 12 of support 10 can be permanently or removably attached to the support 10 by an adhesive, screw-fit, friction-fit, or any other retaining method known to one of ordinary skill in the art, or can be made integral therewith. According to various embodiments, a purification device can be formed from SEIE particles encapsulated by an inert porous resin that provides support for particles and access to the sample.

According to various embodiments and as shown in FIGS. 7a-c, purification device 75 can be inserted into a sample well 30 having a sample solution 34 therein. The purification device 75 can be inserted so that the support 10 contacts the sample well 30, sealing the sample well during reaction of the sample solution 34 and popsicle stick 75. The purification device 75 is kept in contact with the sample solution 34 for a period of time sufficient to remove substantially all impurities, for example, at least 70%, at least 80%, at least 90%, or at least 95% of impurities from the sample solution 34. After a sufficient time, the purification device 75 can be separated from the purified solution 38 in sample well 30. According to various embodiments, the purified sample can be separated from the purification device, for example, by movement of the sample well, or by opening a closable valve in the sample well to allow the purified sample to flow from the sample well. The used purification device can be discarded, washed and reused. The used purification device can be used to transfer the adsorbed material to another reaction chamber in a process also referred to herein as purification.

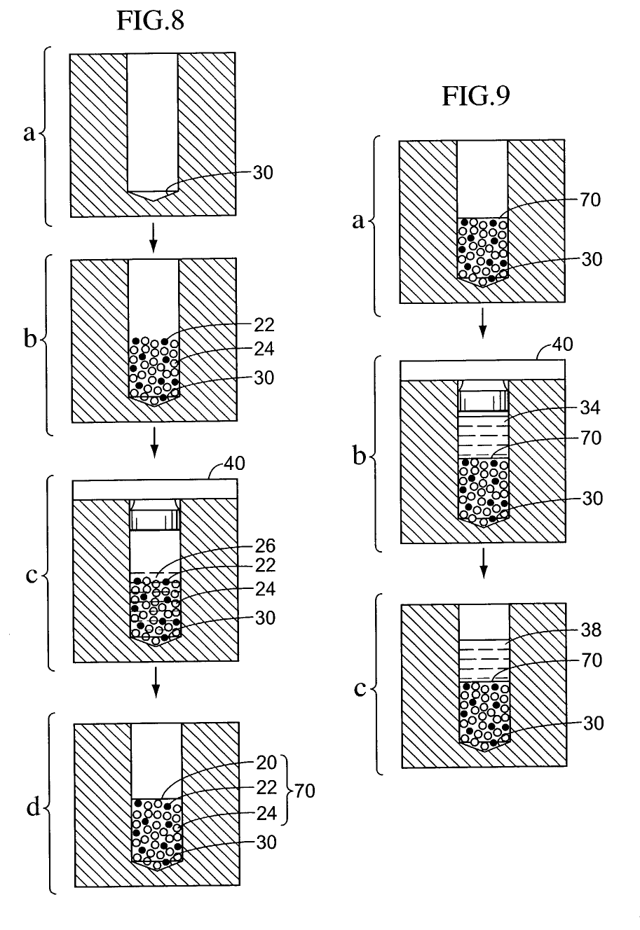

According to various embodiments and as shown in FIGS. 8a-d, a purification device 70 in the form of a gel plug can be formed from a size-exclusion resin 20 and ion-exchange particles 22, 24. The ion-exchange particles 22, 24 can be added to a receptacle, for example, a mold or a sample well 30. If the ion-exchange particles are added to a mold, the mold can be the same size as, or slightly smaller than, the sample well with which the gel plug can be used for purification of a sample solution. A monomer solution 26 as described previously herein can be added to the ion-exchange particles 22, 24 in the sample well 30. A cover 40 can be placed over the sample well and the monomer solution 26 can be polymerized and/or cross-linked to form a size-exclusion resin 20 in the form of a gel plug containing the ion-exchange particles 22, 24. The ion-exchange particles can be below, flush with, or protrude slightly beyond the size-exclusion resin at a surface of the gel plug that contacts the sample solution. The gel plug 70 can be used as a purification device in the receptacle in which it was formed, or in another receptacle. For example, a gel plug can be formed for use in a column, including a column of a microfluidic device, or a gel plug can be formed as a sheet for use as a filter material. According to various embodiments, a gel plug can be formed from SEIE particles encapsulated by an inert porous resin that provides support for particles and access to the sample.

As shown in FIGS. 9a-c, the gel plug 70 can be situated in the sample well in which it was formed, or placed in a sample well 30. According to various embodiments, gel plug 70 fits snugly into sample well 30. Gel plug 70 can be slightly smaller than sample well 30 such that a sample solution 34 can flow around gel plug 70 in sample well 30. For purification of a sample solution 34, the sample solution 34 is contacted with gel plug 70 in sample well 30. A cover 40 can be set over and in contact with sample well 30. Cover 40 can minimize loss of sample solution 34 due to evaporation, and/or prevent contaminants from entering sample solution 34. The sample solution can be kept in contact with gel plug 70 for a period of time sufficient to remove substantially all impurities, for example, at least 70%, at least 80%, at least 90%, or at least 95% of impurities from the sample solution 34. After a sufficient time, the purified sample solution 38 can be removed from the sample well 30, leaving the gel plug 70 containing the adsorbed contaminants in sample well 30. Alternately, gel plug 70 can be removed from sample well 30, and the purified solution 38 retained in sample well 30. After use, gel plug 70 can be discarded, washed and reused, or can be used to transfer the adsorbed material for use in a subsequent reaction. According to various embodiments, a sample well array or receiving well array can be provided wherein each well has a gel plug therein. According to various embodiments, the gel plug can be placed in a multi-column filtration array as the filter material.

According to the embodiments described, examples of which are shown in FIGS. 2-9 wherein the substrate is a size-exclusion resin, the ion-exchange particles contained in the substrate can be anionic ion-exchange particles, cationic ion-exchange particles, or a combination thereof. The ion-exchange particles can have an ionic solid core material, or can have a solid core material coated with an ionic resin, as described elsewhere herein. According to various embodiments described herein, examples of which are shown in FIGS. 2-9 wherein SEIE particles are encapsulated by an inert porous resin, the SEIE can be anionic, cationic, or a mixture of such.

According to various embodiments, a purification device can include both anionic ion-exchange particles, cationic ion-exchange particles, anionic SEIE particles, cationic SEIE particles, or mixtures of such. Wherein a mixture of anionic particles and cationic particles is used, whether the mixture is ion-exchange only, SEIE only, or a mixture of ion-exchange and SEIE, the particles can be present in stoichiometrically equal amounts, such that the ion-exchange capacity for anions and cations is approximately equivalent. According to various embodiments, the anionic particles and cationic particles can be present in amounts which are not stoichiometrically equal.

One or more of the purification device and sample container can be moved relative to one another to contact the purification device with a sample in the sample container, and to separate the purification device from the purified sample in the sample container. For example, the purification device can be inserted into and removed from the sample container, or the sample container can be moved into a position surrounding the purification device and removed from the purification device after purification of the sample, or any combination thereof.

A sample to be purified can be added to a sample container before, after or simultaneous with addition of a purification device to the sample container. A purified sample can be separated from the purification device by removal of the purification device or removal of the purified sample from the sample container.

As used herein, a sample container can include any arrangement suitable for containing or retaining the purification device and a sample. For example, the sample container can include a sample well of a sample well array, a test tube, a Petri dish, a column, a portion of a pathway of a microfluidic device, or any other suitable container known to those of ordinary skill in the art.

According to various embodiments, sample purification can occur in a bulk mode on a purification device as described herein. The ion-exchange capacity of a purification device as described herein for a given ion is improved over prior art methods and apparatuses for ion-exchange.

According to various embodiments, purification of a sample using a purification device can occur in ten minutes or less, five minutes or less, or two minutes or less.

According to various embodiments, the selectivity of a purification device can be determined by the nature of the size-exclusion resin, the charge of the ion-exchange particle, or a combination thereof. The properties of the size-exclusion resin can be varied by, for example, choice of synthesis conditions, which can affect the pore size of the resin. Controlling an effective pore size of the size-exclusion resin can enable optimization of the device for different applications.

According to various embodiments, a size-exclusion resin can be polymerized and/or a cross-linked monomer such as a hydrogel. As used herein, unless otherwise specified, the terms “polymer,” “polymerization,” “polymerize,” “cross-linked product,” “cross-linking,” “cross-link” and other like terms are meant to include both polymerization products and methods, and cross-linked products and methods wherein the resultant product is a three-dimensional structure, as opposed to, for example, a linear polymer. The degree of cross-linking of the size-exclusion resin can be varied in order to vary the size of the pores of the size-exclusion resin. For example, the pore size of the size-exclusion resin can be large enough to allow relatively small ions, such as, for example, chloride, nucleotides, or other small molecules, to permeate through the size-exclusion resin. The pore size of the size-exclusion resin can be small enough to prevent any relatively large molecules, such as DNA, from permeating through the size-exclusion resin. According to various embodiments, the size-exclusion resin can be hydrophilic to reduce passive adsorption or absorption of biomolecules such as, for example, ssDNA fragments.

According to various embodiments, a size-exclusion resin can be a cross-linked product of two or more reactive monomeric units. The monomeric units can be water-soluble monomeric units. As used herein, the term “water-soluble” includes materials with any degree of water solubility from slightly water-soluble to highly water-soluble, and materials that are swellable in water. The monomeric units can be nitrogen-containing, oxygen-containing, or both. The size-exclusion resin can be a homopolymer or a copolymer. The size-exclusion resin can be a reaction product of acrylamide and a cross-linker, for example, N,N′-methylenebisacrylamide, 2,2-bisacrylamidoacetic acid, N,N′-diacryloylpiperazine, tri(meth)acryloylperhydro-s-triazine, or a combination thereof. According to various embodiments, exemplary water-soluble monomers suitable for preparing size-exclusion resin can include, but are not limited to, (meth)acrylamide, N-methyl(meth)acrylamide, N,N-dimethyl(meth)acrylamide, N-methyl-N-ethyl (meth)acrylamide, N-ethyl (meth)acrylamide, N,N-diethyl (meth)acrylamide, N-isopropyl (meth)acrylamide, N-hydroxymethyl (meth)acrylamide, N-vinylformamide, N-vinylacetamide, N-methyl-N-vinylacetamide, precursor of vinyl alcohol, for example, vinyl acetate, 2-hydroxyethyl (meth)acrylate, 3-hydroxypropyl (meth)acrylate, vinypyrrolidone, vinyloxazolidone, vinylmethyloxazolidone, N-(meth)acrylylcinamide, poly(ethyleneglycol) mono(meth)acrylate, other suitable monomers known to one of ordinary skill in the art, or a combination thereof. The size-exclusion resin can be neutral, anionic, for example, containing acrylic acid as a co-monomer, or cationic, for example, containing 2-acryloylethyl trimethyl ammonium chloride as a co-monomer. According to various embodiments, the size-exclusion resin can be hydrophilic. The size-exclusion resin can be a cross-linked polymer network of polymers capable of swelling in water, for example, hydrogels. Exemplary hydrogels are described, for example, in U.S. Pat. No. 6,380,456 B1, incorporated herein in its entirety by reference. The size-exclusion resin, once formed, can be non-water soluble. According to various embodiments, the size-exclusion resin can prevent adsorption of ssDNA fragments and/or double-stranded DNA (dsDNA) fragments.

According to various embodiments, the size-exclusion resin can be formed with pores of a pre-determined size. The pores can be of the same or varying size. The pores can function as the size-exclusion factor for preventing molecules larger than a certain size from passing through the size-exclusion resin to the ion-exchange core which is micro-encapsulated by the size-exclusion resin. According to various embodiments, the size-exclusion resin can be formed by cross-linking one or more reactive monomer by addition of a cross-linker, for example, N,N′-methylenebisacrylamide, or a free-radical initiator. The cross-linker or initiator can be added in an amount of from 1.0 mol % to 100 mol %. According to various embodiments, the cross-linker or initiator can be added in an amount of from 1.0 mol % to 80 mol %, from 2.0 mol % to 50 mol %, from 5 mol % to 30 mol %, or from 10 mol % to 20 mol %. The amount of cross-linker or initiator used to form the size-exclusion resin is at least one factor in determining the size of the pores of the size-exclusion resin, and the size-exclusion ability of the size-exclusion resin. According to various embodiments, the choice of cross-linker or initiator, and/or selection of the reaction conditions, can control the amount of cross-linking of the size-exclusion resin. For example, various multifunctional cross-linkers, for example, tri(meth)acryloylperhydro-s-triazine can be used that have varying amounts of functionality. The appropriate amount of a cross-linker to use to form a desired size-exclusion resin pore size can be determined by those of ordinary skill in the art based on the functionality of the cross-linker chosen, the reaction conditions, and other factors as known to those of ordinary skill in the art. The size-exclusion resin pore size can be equal to or smaller than a 10 nucleotides (“nt”) ssDNA. The size-exclusion resin pore size can be equal to or smaller than a 100 nt ssDNA.

According to various embodiments wherein about 50% or more of the pores of the size-exclusion resin have a pore size capable of excluding a molecule equal to or larger than a 100 nt ssDNA, nucleotides, oligonucleotide primers less than 100 nt in size, and buffer salts can pass through the size-exclusion resin while 100 nt or larger molecules are deflected by the size-exclusion resin. Wherein 50% or more of the pores of the size-exclusion resin have a pore size capable of excluding a molecule equal to or larger than a 100 nt ssDNA, the size-exclusion resin can be used with ion-exchange particles for purification of biological samples, for example, PCR products, to separate larger DNA, for example dsDNA, from ssDNA, free nucleotides, and salts.

According to various embodiments wherein 50% or more of the pores of the size-exclusion resin have a pore size capable of excluding a molecule equal to or larger than a 10 nt ssDNA, salts and nucleotides, for example, present in a sample to be purified, can pass through the size-exclusion resin. Wherein 50% or more of the pores of the size-exclusion resin have a pore size capable of excluding a molecule equal to or larger than 10 nt, the size-exclusion resin can be used with ion-exchange particles for purification of biological samples, for example, from a sequencing reaction. Purification of a sequencing reaction sample can remove dye-labeled dideoxynucleotides and salts from the sequencing reaction sample by allowing such sample components to pass through the size-exclusion resin and react with the ion-exchange particles, leaving a purified sample containing ssDNA in an amount of 70% or more, 80% or more, 90% or more, or 95% or more of the eluted sample volume.

According to various embodiments, an ion-exchange particle can be an anionic or cationic material. The ion-exchange particle can be a polymer, cross-linked polymer, or inorganic material, for example, silica. The ion-exchange particle can be a solid core material capable of ion-exchange, or a solid core material treated with an ion-exchange resin. The ion-exchange particle can be surface-activated. The ion-exchange particle can be non-magnetic, paramagnetic, or magnetic. Exemplary ion-exchange particle materials include Macro-Prep® ion-exchange resins from Bio-Rad, and Nucleosil® silica-based ion-exchange resins from Macherey-Nagel.

According to various embodiments wherein the ion-exchange particle includes a solid core material capable of ion-exchange, the solid core material can be macroporous silica, controlled pore glass (CPG), a macroporous polymer microsphere with internal pores, other porous materials as known to one of ordinary skill in the art, or a combination thereof. The solid core material can have various surface features, including, for example, pores, crevices, cracks, or depressions. The solid core material can include sodium oxide, silicon dioxide, sodium borate, or a combination thereof. The solid core material can be modified to be capable of ion-exchange, for example, cation-exchange or anion-exchange. Modification of the solid core material can include treatment of the solid core material to form cationic or anionic substituent groups on the surfaces of the solid core material. As used herein, the term “surface” can include an external surface and internal surfaces, for example, the surfaces of voids or pores within the solid core material. The solid core material can be modified to include tertiary amino groups, quaternarized ammonium groups, at least one carboxylic acid group, at least one sulfonic acid group, other cationic or anionic functional groups known to one of ordinary skill in the art, or a combination thereof on the surface of the solid core material. According to various embodiments, the solid core material can be porous, microporous, or macroporous. The solid core material can have an average pore size of less than or equal to 1000 Angstroms, from 100 Angstroms to 1000 Angstroms, or less than or equal to 100 Angstroms. The average diameter of the solid core material can be from 0.1 μm to 100 μm, from 1 μm to 50 μm, or from 2 μm to 20 μm, according to various embodiments. The average diameter of the solid core material can be 100 μm or less, 50 μm or less, or 20 μm or less.

According to various embodiments, a solid core material can adsorb an ion-exchange resin onto the external surface, internal surface, or both the external and the internal surface of the solid core material to form an ion-exchange particle. As used herein, the term “resin” can encompass a resin or a gel. The ion-exchange resin can be a cation-exchange resin or an anion-exchange resin. The ion-exchange resin can include tertiary amino groups, quaternarized ammonium groups, at least one carboxylic acid group, at least one sulfonic acid group, or a combination thereof. Suitable anion-exchange resins and cation-exchange resins are known to one of ordinary skill in the art.

According to various embodiments, the ion-exchange resin can be sequestered into the pores of the solid core material, for example, a macroporous silica particle. Filling at least a portion of the pores of the solid core material and/or coating the external surface of the solid core material with the ion-exchange resin can increase the ion-exchange capacity of the ion-exchange particle over traditional ion-exchange resins. The ion-exchange capacity of the ion-exchange particle can be improved by increasing a mass of ion-exchange resin, such as quaternary ammonium resin, on the external surface and/or on the internal surfaces of the pores of the solid core material of the ion-exchange particle. The ion-exchange capacity of the ion-exchange particle can be improved by selection of cationic or anionic functional groups on the external surface, internal surfaces of the pores, or both internal surfaces and external surface of the solid core material.

According to various embodiments, the ion-exchange resin can be formed in situ on the solid core material, as described, for example, in concurrently filed U.S. patent application Ser. No., ______, to Lau et al, entitled “SIZE-EXCLUSION ION-EXCHANGE PARTICLES,” Attorney Docket No. 4885, which is incorporated herein in its entirety by reference. The ion-exchange resin can be the product of one or more monomer, one or more polymer, or a combination thereof, according to various embodiments. For example, a solid core material of SiO₂ having an average pore size of about 1000 Angstroms, a void volume of about 0.95 cc/g, and a diameter of about 5 μm, can be added to a solution of polyethyleneimine in methanol and incubated for a time sufficient to impregnate the polyethyleneimine on all internal and external surfaces of the solid core material. According to various embodiments, polyethyleneimine can be adsorbed due to hydrogen bonding with silanol groups in the solid core material. The adsorbed polyethyleneimine can be reacted with a second compound, such as, for example, 1,3-dibromopropane, in a solvent, for example, dioxane, followed by placement in water, to form a gel that functions as an anion-exchange resin on the solid core material, forming an ion-exchange particle. According to various embodiments, the said anion-exchange resin can be quarternized by reacting the cross-linked network with an alkyl halide, for example, methyl bromide, resulting in an strong anion exchange resin. By other methods known to one of ordinary skill in the art, other anion-exchange resins or cation-exchange resins can be impregnated or retained on at least a portion of the internal surfaces, on at least a portion of the external surface, or on at least a portion of all surfaces of the solid core material of the ion-exchange particle.

According to various embodiments, purification of a sample can be accomplished by ion-exchange. Displacement of counter-ions from ion-exchange particles of a device as described herein during ion-exchange can release a large number of counterions into a sample solution. According to various embodiments, anionic ion-exchange particles and cationic ion-exchange particles can both be present during purification of a sample such that counterions of the ion-exchange particles react to form a neutral molecule, for example, water.

According to various embodiments, the purification device can include an ion-exchange particle having a lower mobility counter-ion, for example, octane sulfonate. The device can include an ion-exchange particle can contain a volatile counter-ion, for example, acetate, which can later be removed from a sample solution. The counter-ion for an anionic ion-exchange particle can be, for example, a halide or hydroxide. The counter-ion for a cationic ion-exchange particle can be, for example, hydrogen.

According to various embodiments, the sample for purification can be a PCR product solution containing, for example, buffer salts, metal ions, polymerase, nucleotides, oligonucleotide primers, and other components. According to various embodiments, PCR products can be used in subsequent enzymatic reactions that can be sensitive to at least some of the artifacts found in a sample solution containing the PCR products. For example, free nucleotides and oligonucleotide primers can interfere with downstream enzymatic reactions. According to various embodiments, a size-exclusion resin in a purification device can have a pore size capable of excluding a molecule equal to or larger than a 100 nt ssDNA, allowing nucleotides, oligonucleotide primers less than 100 nt in size, and buffer salts, to pass through the size-exclusion resin and make contact with the ion-exchange particle, becoming trapped therein. 100 nt or larger molecules can remain in the sample solution. According to various embodiments, at least 50% or more of the surface of the size-exclusion resin is capable of excluding a molecule equal to or larger than a 100 nt ssDNA, and allowing nucleotides, oligonucleotide primers, and buffer salts less than 100 nt in size to pass through the size-exclusion and be trapped by the ion-exchange particles. The resulting purified sample solution can contain purified PCR products in a desalted environment, and can be used in downstream reactions and analyses. According to various embodiments, PCR purification can be directed toward purifying larger dsDNA separate from smaller ssDNA, free nucleotides, and salts. PCR product purification using a purification device can isolate a 250-600 bp amplicon, can remove 44 nt primers and/or nucleotides, or can both isolate and remove.

According to various embodiments, a sample can be a DNA sequencing reaction solution containing, for example, buffer salts, metal ions, polymerase, nucleotides, oligonucleotide primers, and other components. Purification of sequencing reaction solutions can have different requirements than purification of PCR reaction solutions. For example, according to various embodiments, finished sequencing reactions can contain residual dye-labeled dideoxynucleotides (terminators) that can be removed, according to various methods, prior to electrophoretic analysis and DNA sequencing or basecalling. Removing terminators can remove “blobs” that would otherwise be caused and lead to errors in DNA sequencing or basecalling. According to various embodiments, capillary sequencers can use electrokinetic injection as a means to introduce DNA sequencing reaction samples. The presence of salts in the samples can effect the introduction of the sample into the capillary. DNA sequencing reaction samples can be highly desalted by purification with a purification device.

According to various embodiments, a sample solution purified with a purification device as described herein can have a salt connection less than or equal to 100 μM, or less than or equal to 50 μM. A sample solution purified by a purification device according to various embodiments, suitable for electrokinetic capillary injection.

A sequencing reaction purification using the purification device can separate ssDNA, for example, ssDNA of from 10 nt to 800 nt in size, from, for example, dye-labeled nucleotides and salts.

According to various embodiments, a kit for forming a purification device, and/or conducting purification of a sample, is provided. The kit can include ion-exchange particles, a reactive monomer such as a polymerizable or cross-linkable solution capable of forming a size-exclusion resin, particles of an affinity adsorbent and a receptacle capable of receiving the particles, the solution, or both. The kit can contain one or more of an initiator or cross-linker. The kit can contain size-exclusion ion-exchange particles. The kit can contain a substrate or support structure to which the ion-exchange particles in a size-exclusion resin, or size-exclusion ion-exchange particles, can be attached, adhered, embedded, or otherwise bound or contacted. According to various embodiments, the kit can further include a chemical for softening a substrate or support structure, and/or a device for heating the substrate, support structure, or particles. The kit can contain heparin. The kit can contain a sample container. According to various embodiments, the kit can be used to construct a purification device as described herein. The purification device can be used with the sample container of the kit, or any other sample container, to purify a sample solution as described herein.

The following publications are incorporated herein in their entireties by reference: Hui Wen Tai, et al., “Macroporous silica monoliths by high internal phase emulsion polymerization”, Polym. Matl. Sci. Eng., 86, 235, 2002; Wolfgang Haller, “Application of controlled pore glass in solid phase biochemistry”, Chapter 11, pages 523-597 in Solid Phase Biochemistry, Editor: William H. Scouten, John Willy & Sons, New York, 1983; and Andrew J. Alpert, et al., J. Chromatog., 185, 375, 1979.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A purification device comprising:
a substrate comprising ion-exchange material and size exclusion resin, wherein the ion-exchange material at least partially contacts the size-exclusion resin.

2. The device of claim 1, wherein the ion-exchange material comprises cationic-exchange particles.

3. The device of claim 1, wherein the ion-exchange material comprises anionic-exchange particles.

4. The device of claim 1, wherein the device further comprises a polymeric material.

5. The device of claim 4, wherein the polymeric material comprises polystyrene, a co-polymer of polystyrene, a petroleum based polymer, a petroleum based co-polymer, a petroleum-based homopolymer, or a combination thereof.

6. The device of claim 5, wherein the polymeric material forms a support with a protrusion extending therefrom, wherein the substrate is affixed to at least a distal end of the protrusion.

7. The device of claim 6, wherein the ion-exchange material comprises a cation-exchange material and an anionic-exchange material.

8. The device of claim 7, wherein the substrate is at least one of sulfonic acid-treated and heparin-treated.

9. The device of claim 1, wherein the ion-exchange material is ion-exchange particles, and wherein said ion-exchange particles are micro-encapsulated by the size-exclusion resin.

10. The device of claim 1, wherein the ion-exchange material is ion-exchange particles, and wherein said ion-exchange particles are encapsulated in the size-exclusion resin.

11. The device of claim 10, wherein the size-exclusion resin comprises a neutrally-charged cross-linked product of two or more reactive monomeric units.

12. The device of claim 10, wherein the size-exclusion resin comprises the reaction product of an acrylamide.

13. The device of claim 10, wherein the size-exclusion resin comprises at least one of a poly((meth)acrylamide material, a poly(N-methyl (meth)acrylamide) material, a poly(N,N-dimethylacrylamide) material, a poly(N-ethyl (meth)acrylamide) material, a poly(N-n-propyl (meth)acrylamide) material, a poly(N-iso-propyl (meth)acrylamide) material, a poly(N-ethyl-N-methyl (meth)acrylamide) material, a poly(N,N-diethyl (meth)acrylamide) material, a poly(N-vinylformamide) material, a poly(N-vinylacetamide) material, a poly(N-methyl-N-vinylacetamide) material, a poly(vinyl alcohol) material, a poly(2-hydroxyethyl (meth)acrylate) material, a poly(3-hydroxypropyl (meth)acrylate) material, a poly(vinylpyrrolidone) material, a poly(ethylene oxide) material, a poly(vinyl methyl ether) material, a poly(N-(meth)acrylylcinamide) material, a poly(vinyloxazolidone) material, a poly(vinylmethyloxazolidone) material, a poly(2-methyl-2-oxazoline) material, a poly(2-ethyl-2-oxazoline)material, a polymer of poly(ethylene glycol) acrylate, a polymer of poly(ethyleneglycol) methacrylate, a water-soluble polysaccharide material, hydroxymethylcellulose, and hydroxyethylcellulose.

14. The device of claim 10, further comprising a support, and wherein the substrate is disposed in or on the support.

15. The device of claim 14, wherein the support comprises a sample well.

16. The device of claim 14, wherein the support is a portion of a pathway of a microfluidic device.

17. The device of claim 10, wherein the substrate is coated on the support.

18. The device of claim 17, wherein the support comprises a surface with a protrusion extending therefrom, the protrusion having a terminal end, and the substrate is supported by the terminal end of the protrusion.

19. The device of claim 17, wherein the support comprises at least one of polystyrene, a co-polymer of polystyrene, a petroleum-based polymer, a petroleum-based co-polymer, a petroleum-based homopolymer, and combinations thereof.

20. The device of claim 9, wherein said size-exclusion resin comprises a reaction product of an acrylamide.

21. A method of manufacturing a device, comprising:
providing ion-exchange particles;
providing a support including at least one protrusion extending therefrom; and
contacting the protrusion with the ion-exchange particles such that the ion-exchange particles are affixed to the protrusion.
contacting the ion-exchange particles with a size-exclusion resin to at least one of encapsulate and micro-encapsulate the ion-exchange particles.

22. The method of claim 21, wherein the particles include size-exclusion ion-exchange particles.

23. The method of claim 21, wherein the at least one protrusion has a glass transition temperature and a melting temperature, and the method further comprises softening the protrusion by heating the protrusion to a temperature of from the glass transition temperature to the melting temperature.

24. The method of claim 21, further comprising softening the protrusion by chemically treating the protrusion.

25. The method of claim 21, further comprising softening the ion-exchange particles by at least one of heating the ion-exchange particles and chemically-treating the ion-exchange particle.

26. The method of claim 21, providing ion-exchange particles comprises providing ion-exchange particles dispersed in a monomer solution that is capable of polymerization.

27. The method of claim 21, further comprising treating the substrate with at least one of sulfonic acid and heparin.

28. A method of manufacturing a purification device, comprising:
providing a mold;
disposing ion-exchange particles in the mold;
disposing reactive monomer solution to the mold; and
reacting the monomer solution to form a size-exclusion resin that embeds the ion-exchange particles.

29. The method of claim 28, further comprising:
providing a support having at least one protrusion extending therefrom;
disposing the protrusion into the mold; and
reacting the reactive monomer solution to form a size-exclusion resin attached to at least a portion of the protrusion.

30. The method of claim 28, wherein the mold is a well.

31. A method comprising:
providing a purification device comprising a substrate comprising ion-exchange material and size exclusion resin, wherein the ion-exchange material at least partially contacts the size-exclusion resin;
providing a sample solution; and
contacting the purification device with the sample solution for a period of time sufficient to remove impurities from the sample solution and form a purified sample solution.

32. The method of claim 31, wherein contacting comprises positioning the purification device and the sample solution in a container.

33. The method of claim 32, wherein the container is a sample well, a test tube, a receiving well, a column, or a portion of a pathway of a microfluidic device.

34. The method of claim 31, wherein the period of time is from one minute to ten minutes.

35. The method of claim 31, wherein the period of time is less than five minutes.

36. The method of claim 31, wherein the period of time is less than two minutes.

37. A kit for purification of a sample solution, wherein the kit comprises:
ion-exchange particles;
a reactive monomer composition capable of forming a size-exclusion resin; and
a receptacle capable of receiving the ion-exchange particles and the reactive monomer composition.

38. The kit of claim 37, further comprising a support.

39. The kit of claim 38, wherein the support includes a plurality of protrusions.

40. The kit of claim 37, further comprising heparin.

41. The kit of claim 37, further comprising sulfonic acid.
